(19) United States
(12) Patent Application Publication
(10) Pub. No.: US 2010/0066981 A1
(43) Pub. Date: Mar. 18, 2010

(54) Projector and method of cooling light source of projector

(75) Inventor: Takeshi Kato, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC DISPLAY SOLUTIONS, LTD., TOKYO (JP)

(21) Appl. No.: 12/311,022

(22) PCT Filed: Sep. 13, 2007
(86) PCT No.: PCT/JP2007/068319

§ 371 Date: Mar. 17, 2009

(30) Foreign Application Priority Data
Oct. 4, 2006 (JP) 2006-272996

(51) Int. Cl. G03B 21/16

(52) U.S. Cl. 353/57

(57) ABSTRACT

There are provided a projector which is capable of managing the temperature of the light source highly accurately, and a method of cooling the light source of a projector. The projector includes light source means 2 for emitting light for projecting an image, holding means 4 for holding air, holding means 4 including air discharging means 4b directed toward light source means 2, air pump means 3 for holding air in holding means 4 and compressing air in holding means 4, pressure detecting means 5 for detecting a pressure in holding means 4, and control means 7 for controlling operation of air pump means 3 based on the pressure detected by pressure detecting means 5.

### TECHNICAL FIELD

The present invention relates to a projector and a method of cooling a light source of a projector, and more particularly to a projector with a mechanism for cooling a light source and a method of cooling the light source of a projector.

### BACKGROUND ART

There are market demands for projectors that are small in size and capable of projecting highly bright images. To meet such market demands, projectors have begun incorporating a small-size light source for emitting highly luminous light and an air-cooling device for cooling the light source.

Patent Document 1 (JP-A No. 2003-5289) discloses a projector whose light source is cooled by a fan. Patent Document 2 (JP-A No. 4-60534) discloses a projector wherein the operation of a cooling fan is controlled based on the output of an air speed sensor and the output of a temperature sensor.

There is also known a projector whose light source is cooled by an air-cooling device employing an air pump. In this projector, air discharged from the air pump is compressed in a tube, and the compressed air is expelled from an outlet port of the tube to the light source.

The air pump is actuated at a constant rotational speed or a constant drive voltage.

Patent Document 1: JP-A No. 2003-5289

Patent Document 2: JP-A No. 4-60534

### DISCLOSURE OF THE INVENTION

### Exemplary Problems to be Solved by the Invention

The control process of keeping the rotational speed or the drive voltage of the air pump constant suffers the following problems:

Due to the differences between individual air pumps, the differences between the structures of individual cooling paths (tubes) through which cooling air is to pass, and the differences between the areas of individual outlet ports, the flow rates of air applied to the light sources of individual projectors do not have a constant value. Therefore, the temperature management of the light source is difficult to perform. The management of cooling the light sources of projectors needs to be highly accurate.

The pressure of air in the cooling path varies depending on the ambient temperature. As the pressure of air in the cooling path increases, the flow rate of air discharged from the air outlet port increases. Accordingly, the flow rate of air discharged from the air outlet port also varies depending on the ambient temperature. This makes the temperature management of the light source difficult.

When the ability of the air pump is lowered due to aging, the cooling capability is also lowered.

It is an exemplary purpose of the present invention to provide a projector which is capable of managing the temperature of the light source highly accurately, and a method of cooling the light source of a projector. In other words, it is an exemplary purpose of the present invention to provide a projector which will solve the above problems, and a method of cooling the light source of a projector.

### Means for Solving the Problems

In order to achieve the above and other exemplary purposes, a projector according to the present invention includes a light source for emitting light for projecting an image; a holding unit for holding air, the holding unit including an air discharging unit directed toward the light source; an air pump for holding air in the holding unit and compressing air in the holding unit; a pressure detector for detecting a pressure in the holding unit; and a controller for controlling operation of the air pump based on the pressure detected by the pressure detector.

A method of cooling a light source of a projector including a light source for emitting light for projecting an image, a holding unit for holding air, the holding unit including an air discharging unit directed toward the light source, and an air pump for holding air in the holding unit and compressing air in the holding unit, the method being carried out by the projector, the method includes: detecting a pressure in the holding unit; and controlling operation of the air pump based on the detected pressure.

### EXEMPLARY ADVANTAGES OF THE INVENTION

According to the present invention, it is possible to manage the temperature of the light source highly accurately.

### BRIEF DESCRIPTION OF THE DRAWINGS

FIG. 1 is a block diagram of a projector according to an exemplary embodiment of the present invention;

FIG. 2 is a flowchart of a control sequence of making the pressure in a piping tube constant; and

FIG. 3 is a flowchart of an operation sequence of detecting a malfunction of a cooling mechanism.

### DESCRIPTION OF REFERENCE CHARACTERS

1 liquid crystal panel
2 lamp
3 air pump
4 piping tube
4a inlet port
4b outlet port
5 pressure sensor
6 ADC
7 controller
8 CPU
9 pump drive circuit
10 video signal processor

### BEST MODE FOR CARRYING OUT THE INVENTION

An exemplary embodiment of the present invention will be described below with reference to the drawings.

FIG. 1 is a block diagram of a projector according to an exemplary embodiment of the present invention. The projector according to the exemplary embodiment of the present invention will be described below with reference to FIG. 1.

As shown in FIG. 1, the projector comprises liquid crystal panel 1, lamp 2, air pump 3, piping tube 4, pressure sensor 5, ADC (Analog/Digital Converter) 6, controller 7, and video signal processor 10. Controller 7 includes central processing unit (CPU) 8 and pump drive circuit 9.

Liquid crystal panel 1 is an example of an image forming device, and forms an image depending on an image signal supplied from video signal processor 10. The image forming device is not limited to a liquid crystal panel, but may comprise a different structure, e.g., a DMD (Digital Micromirror Device), etc. The image forming device is an example of image forming means.

Lamp 2 is an example of a light source, and applies light to liquid crystal panel 1 to project an image formed by liquid crystal panel 1. The light source is an example of light source means.

Air pump 3 is controlled in operation by controller 7, and discharges air. Air pump 3 is controlled in operation according to a pulse width modulation (PWM) control process performed by controller 7. According to the present exemplary embodiment, the rotational speed of air pump 3, i.e., the flow rate of air discharged thereby, increases as the duty ratio of drive pulses supplied from controller 7 increases. Air pump 3 is an example of air pump means.

Piping tube 4 is an example of a holder, and the holder is an example of holding means. Piping tube 4 has inlet port 4a and outlet port 4b. Outlet port 4b is an example of an air discharger, and the air discharger is an example of air discharging means. Inlet port 4a is connected to air pump 3. Outlet port 4b is disposed so that outlet port 4b confronts lamp 2.

Air discharged from air pump 3 flows through inlet port 4a into piping tube 4 where the air is compressed. The compressed air is then discharged from outlet port 4b toward lamp 2. As the pressure in piping tube 4 becomes higher, the flow rate of air discharged from outlet port 4b increases. Lamp 2 is cooled by the air discharged from outlet port 4b.

The diameter of outlet port 4b is sufficiently smaller than the inside diameter of piping tube 4. For example, the diameter of outlet port 4b may be about one-tenth of the inside diameter of piping tube 4. Therefore, a pressure higher than the atmospheric pressure is developed in piping tube 4. The ratio between the diameter of outlet port 4b and the inside diameter of piping tube 4 is not limited to 1:10, but may be varied.

Pressure sensor 5 serves to detect the pressure in piping tube 4. Pressure sensor 5 provides an analog signal representing the detected pressure to ADC 6. Pressure sensor 5 is an example of pressure detecting means.

ADC 6 converts the analog signal received from pressure sensor 5 into a digital signal, and supplies the digital signal to CPU 8.

If pressure sensor 5 is capable of providing a digital signal representing the detected pressure, then pressure sensor 5 supplies the digital signal to CPU 8. In this case, ADC 6 is dispensed with.

Controller 7 controls the operation of the projector. For example, controller 7 controls the operation of air pump 3 based on the pressure detected by pressure sensor 5. Controller 7 is an example of control means.

CPU 8 controls video signal processor 10 to supply an image signal from video signal processor 10 to liquid crystal panel 1.

CPU 8 also generates control information for controlling air pump 3 (specifically, an instruction for changing the duty ratio of drive pulses) based on the pressure detected by pressure sensor 5. CPU 8 supplies the control information to pump drive circuit 9.

CPU 8 stores a pressure that is set as a target [hereinafter referred to as “target pressure (Y)”]. If the pressure detected by pressure sensor 5 is lower than target pressure (Y), then CPU 8 supplies pump drive circuit 9 with a control signal for increasing the duty ratio of drive pulses. If the pressure detected by pressure sensor 5 is higher than target pressure (Y), then CPU 8 supplies pump drive circuit 9 with a control signal for reducing the duty ratio of drive pulses.

Based on the control information received from CPU 8, pump drive circuit 9 generates setting information for setting a flow rate of air to be discharged from air pump 3. Pump drive circuit 9 supplies a drive signal depending on the setting information to air pump 3.

Specifically, pump drive circuit 9 generates a setting value (setting information) for the duty ratio of drive pulses according to the control information received from CPU 8. Pump drive circuit 9 supplies air pump 3 with drive pulses at the duty ratio of the setting value (drive signal).

CPU 8 also monitors pump drive circuit 9 to read the setting value for the duty ratio of drive pulses. CPU 8 determines a malfunction based on the setting value.

Specifically, CPU 8 stores an upper limit value (upper limit duty ratio: B) and a lower limit value (lower limit duty ratio: C) which define a normal range of setting values. If the setting value that is read from pump drive circuit 9 is outside of the normal range, then CPU 8 judges the situation as a malfunction.

Operation of the projector will be described below.

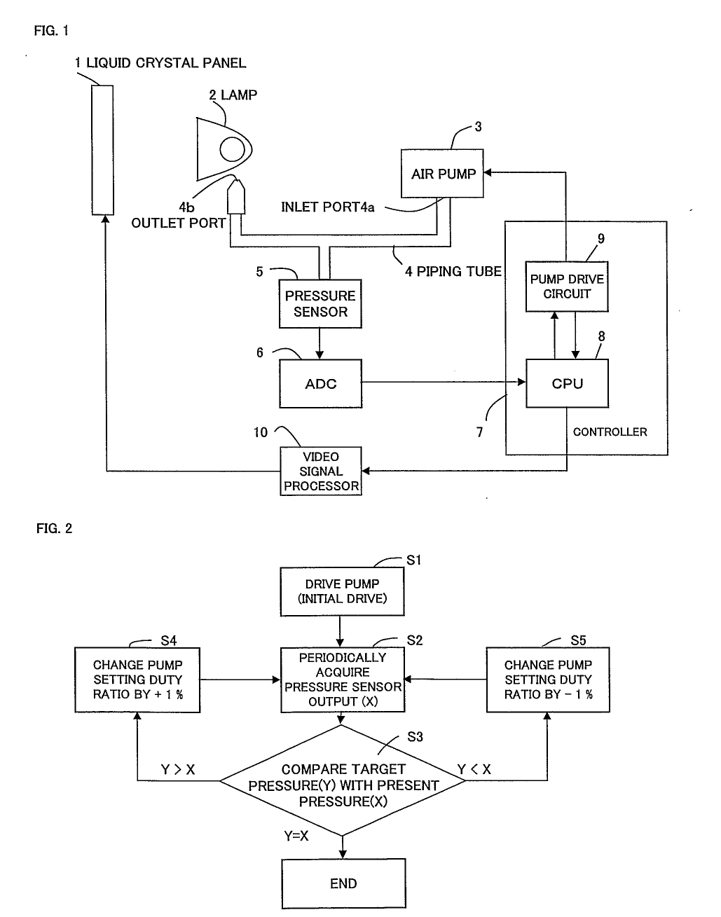

FIG. 2 is a flowchart of a control sequence of making the pressure in piping tube 4 constant.

The pressure in piping tube 4 is correlated with the flow rate of air discharged from outlet port 4b. Consequently, the flow rate of air discharged from outlet port 4b, i.e., the extent to which lamp 2 is cooled, can be controlled by keeping the pressure in piping tube 4 constant.

The control process of making the pressure in piping tube 4 constant will be described below with reference to FIG. 2.

First, controller 7 actuates air pump 3 with drive pulses at an optional duty ratio (step S1).

Specifically, CPU 8 supplies pump drive circuit 9 with control information that represents a duty ratio which has been set for initially cooling lamp 2. Pump drive circuit 9 holds the duty ratio represented by the control information as a setting value. Pump drive circuit 9 then supplies drive pulses at the setting value to air pump 3, thereby actuating air pump 3.

If the duty ratio which has been set for initially cooling lamp 2 is close to a duty ratio that is actually required, then the time needed to set the pressure in piping tube 4 to the target pressure, can be shortened.

Then, CPU 8 periodically acquires the pressure in piping tube 4 detected by pressure sensor 5, through ADC 6 (step S2). The pressure detected by pressure sensor 5 is referred to as “pressure (X)”.

Then, CPU 8 compares target pressure (Y) with present pressure (X) (step S3). If present pressure (X) has not reached target pressure (Y) (Y>X), then CPU 8 supplies pump drive circuit 9 with control information indicating an increase by, for example, 1% of the setting value for the duty ratio.

When pump drive circuit 9 receives the control information, it increases the setting value for the duty ratio of drive pulses by 1%. Pump drive circuit 9 then supplies air pump 3 with drive pulses at the changed setting value (duty ratio), thereby increasing the flow rate of air discharged from air pump 3 (step S4).

As the flow rate of air discharged from air pump 3 increases, the amount of air in piping tube 4 increases. Therefore, the pressure in piping tube 4 rises, increasing the flow rate of air discharged from outlet port 4b.

If present pressure (X) is in excess of target pressure (Y) (Y<X), then CPU 8 supplies pump drive circuit 9 with control information indicating a decrease by 1% of the setting value for the duty ratio.

When pump drive circuit 9 receives the control information, it decreases the setting value for the duty ratio of drive pulses by, for example, 1%. Pump drive circuit 9 then supplies air pump 3 with drive pulses at the changed setting value (duty ratio), thereby decreasing the flow rate of air discharged from air pump 3 (step S5).

As the flow rate of air discharged from air pump 3 decreases, the amount of air in piping tube 4 decreases. Therefore, the pressure in piping tube 4 drops, decreasing the flow rate of air discharged from outlet port 4b.

If present pressure (X) and target pressure (Y) are equal to each other, then CPU 8 does not supply pump drive circuit 9 with control information, so that the flow rate of air discharged from air pump 3 is maintained.

Even after pressure (X) in piping tube 4 has reached target pressure (Y), CPU 8 periodically monitors the output from pressure sensor 5. Therefore, even if pressure (X) in piping tube 4 deviates from target pressure (Y) due to aging of air pump 3 or environmental changes, the pressure in piping tube 4 can be kept constant at all times according to the control loop shown in FIG. 2.

In the above exemplary embodiment, CPU 8 changes the duty ratio by 1% at a time. However, the amount by which duty ratio is changed is not limited to 1%, but may be varied.

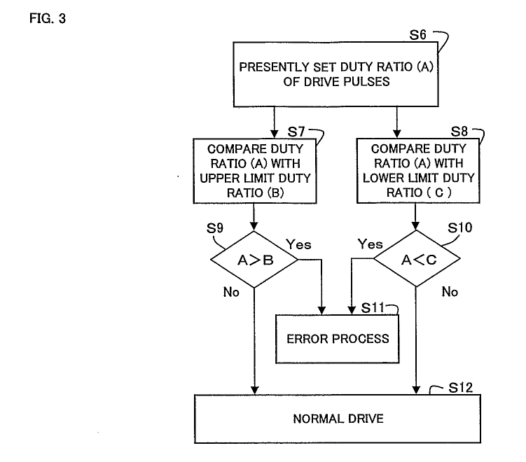

FIG. 3 is a flowchart of an operation sequence of detecting a malfunction of the cooling mechanism while the flow rate of air discharged from air pump 3 is being controlled. The operation sequence of detecting a malfunction of the cooling mechanism will be described below with reference to FIG. 3.

CPU 8 monitors pump drive circuit 9 and periodically reads the setting value for the duty ratio of drive pulses (hereinafter referred to as “duty ratio: A”) (step S6).

Then, CPU 8 compares upper limit duty ratio (B) and lower limit duty ratio (C), which are preset, with the presently set duty ratio (A).

If duty ratio (A) exceeds upper limit duty ratio (B) (A>B) or if duty ratio (A) is smaller than lower limit duty ratio (C) (A<C), then CPU 8 determines an error (a malfunction), and carries out an error process (e.g., a process of displaying “COOLING MALFUNCTION HAS OCCURRED”) on liquid crystal panel 1 (steps S6 through S11).

If duty ratio (A) is smaller than or equal to upper limit duty ratio (B) and greater than or equal to lower limit duty ratio (C) (B≧A≧C), CPU 8 does not determine an error, but actuates air pump 3 normally (steps S6 through S10, S12).

According to the present exemplary embodiment, the pressure in piping tube 4 is controlled so as to be constant at all times. Therefore, the occurrence of a malfunction, aging, and an environmental change cause the duty ratio of drive pulses applied to air pump 3 to vary.

Specific examples of malfunctions that occur in the cooling mechanism will be described below.

### Example 1

### Air is Leaking from Piping Tube 4 Because Piping Tube 4 is Damaged

If the normally set duty ratio is “70%”, then in order to equalize the pressure in the piping tube 4 to the target pressure despite the air leakage, CPU 8 has to make the duty ratio of drive pulses higher than 70%. Therefore, the setting value for the duty ratio gradually increases.

If the upper limit duty ratio is set to “90%”, then when the pressure in the piping tube 4 does not reach the target pressure even with the setting value for the duty ratio being 90%, CPU 8 attempts to further increase the duty ratio. Therefore, the setting value for the duty ratio exceeds the upper limit. CPU 8 now judges the situation as an error.

If the pressure in the piping tube 4 is kept at the target pressure regardless of a malfunction of the cooling path, then there is no problem in cooling lamp 2. Therefore, in a case the upper limit is set to the utmost duty ratio at which air pump 3 can be operable, it is possible to effectively utilize the ability of air pump 3.

### Example 2

### Outlet Port 4b is Clogged with Foreign Matter

If the normally set duty ratio is “70%”, then when outlet port 4b is clogged with foreign matter, the pressure in piping tube 4 increases. Therefore, CPU 8 reduces the duty ratio of drive pulses from 70%. If the lower limit duty ratio is set to “50%”, then when the pressure in the piping tube 4 does not reach the target pressure even with the setting value for the duty ratio being 50%, CPU 8 attempts to further reduce the duty ratio. Therefore, the setting value for the duty ratio is lower than the lower limit. CPU 8 now judges the situation as an error.

### Example 3

### Air Pump 3 is not Rotated Due to a Failure Thereof

Since air pump 3 is shut down, the pressure in piping tube 4 becomes equal to the atmospheric pressure. Therefore, CPU 8 keeps increasing the duty ratio of drive pulses in order to increase the pressure in piping tube 4 up to the target pressure. However, the pressure in piping tube 4 remains equal to the atmospheric pressure even if the duty ratio of drive pulses is set to the upper limit. As CPU 8 attempts to increase the duty ratio, the setting value for the duty ratio exceeds the upper limit. Consequently, CPU 8 now judges the situation as an error.

According to the present exemplary embodiment, controller 7 controls the operation of air pump 3 based on the pressure in piping tube 4. The pressure in piping tube 4 is correlated with the flow rate of air discharged from outlet port 4b. Consequently, it is possible to control the operation of air pump 3 according to the flow rate of air discharged from outlet port 4b.

Lamp 2 can thus be cooled satisfactorily and independently of the differences between individual air pumps 3, the differences between the structures of individual piping tubes 4 through which cooling air is to pass, the differences between the areas of individual outlet ports 4b, changes in the ambient temperature, and aging of air pump 3.

For cooling lamp 2 of the projector, temperature management is highly severe. Since lamp 2 needs to be cooled highly accurately, the cooling control according to the present exemplary embodiment is effective in cooling lamp 2 of the projector.

According to the present exemplary embodiment, if the pressure detected by pressure sensor 5 is lower than the target pressure, controller 7 increases the flow rate of air discharged from air pump 3, and if the pressure detected by pressure sensor 5 is higher than the target pressure, controller 7 reduces the flow rate of air discharged from air pump 3.

It is thus capable of keeping the flow rate of air discharged from air pump 3 constant, thereby maintaining a required cooling capability at all times.

According to the present exemplary embodiment, controller 7 generates the duty ratio of drive pulses based on the pressure detected by pressure sensor 5. Controller 7 controls the flow rate of air discharged from air pump 3 by supplying drive pulses of the generated duty ratio to air pump 3, and determines a malfunction based on the duty ratio of drive pulses.

Since a failure of air pump 3 and a malfunction of piping tube 4 (air leakage, clogging, and the like) can be detected, the safety of the projector is increased.

According to the present exemplary embodiment, controller 7 determines a malfunction if the duty ratio of drive pulses falls outside of the normal range defined by the upper limit duty ratio and the lower limit duty ratio.

Therefore, it is easy to judge a malfunction.

If the upper limit duty ratio and the lower limit duty ratio are set to the utmost and bare values at which air pump 3 can be operated (normally, the lower limit duty ratio is a minimum duty ratio and the upper limit duty ratio is 100%), then the cooling of air lamp 2 is not adversely affected insofar as air pump 3 is able to operate.

For example, even in the event of a failure (e.g., a slight air leakage), there is no problem in cooling lamp 2 insofar as the target pressure is maintained. Consequently, if the borders of the duty ratio range for air pump 3 according to its specifications are used as the upper limit duty ratio and the lower limit duty ratio, the cooling mechanism is of a high allowable capability.

In the above exemplary embodiment, the operation of air pump 3 is controlled under PWM control by controller 7. However, the operation of air pump 3 may be controlled under DC control by controller 7, for example.

In this case, air pump 3 and controller 7 operate as follows:

As the drive voltage supplied from controller 7 becomes higher, air pump 3 has its rotational speed, i.e., the flow rate of air discharged therefrom, increased.

If the pressure detected by pressure sensor 5 is lower than target pressure, then controller 7 increases the drive voltage supplied to air pump 3. If the pressure detected by pressure sensor 5 is higher than target pressure, then controller 7 reduces the drive voltage supplied to air pump 3.

Controller 7 stores an upper limit value and a lower limit value which define a normal range of drive voltages. If the drive voltage supplied to air pump 3 is higher than the upper limit value or if the drive voltage supplied to air pump 3 is lower than the lower limit value, then controller 7 judges the situation as an error.

According to the above exemplary embodiment, the operation of the air pump is controlled based on the pressure in the holder. The pressure in the holder is correlated with the flow rate of air discharged from the outlet port. Consequently, it is possible to control the operation of the air pump according to the flow rate of air discharged from the outlet port.

It is possible to carry out cooling satisfactorily and independently of the differences between individual air pumps, the differences between the structures of individual holders through which cooling air is to pass, the differences between the areas of individual outlet ports, changes in the ambient temperature, and aging of the air pump.

According to the above exemplary embodiment, the controller preferably stores the target pressure. If the pressure detected by the pressure sensor is lower than the target pressure, then the controller preferably increases the amount of air in the holder held by the air pump to increase the flow rate of air discharged from the air discharger. If the pressure detected by the pressure sensor is higher than the target pressure, then the controller preferably reduces the amount of air in the holder held by the air pump to reduce the flow rate of air discharged from the air discharger.

According to the above exemplary embodiment, it is possible to keep the flow rate of air discharged from the outlet port constant. Therefore, the temperature of the light source is stabilized.

According to the above exemplary embodiment, the controller preferably generates the setting information for setting the flow rate of air discharged from the air pump based on the pressure detected by the pressure sensor, supplies a drive signal based on the setting information to the air pump to control the flow rate of air discharged from the air pump, and judges a malfunction based on the setting information.

According to the above exemplary embodiment, since a malfunction of the air pump, the holder, and the air discharger can be detected, the reliability and operability of the projector are increased.

According to the above exemplary embodiment, the controller preferably stores the normal range for the setting information and judges a malfunction if the setting information falls outside of the normal range.

According to the above exemplary embodiment, it is easy to judge a malfunction.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese patent application No. 2006-272996, filed on Oct. 4, 2006, the disclosure of which is incorporated herein in its entirety by reference.

1. A projector, comprising:
light source means for emitting light for projecting an image;
holding means for holding air, said holding means including air discharging means directed toward said light source means;
air pump means for holding air in said holding means and compressing air in said holding means;
pressure detecting means for detecting a pressure in said holding means; and
control means for controlling operation of said air pump means based on the pressure detected by said pressure detecting means in order to keep the pressure in the holding means constant.

2. (canceled)

3. (canceled)

4. (canceled)

5. A method of cooling a light source of a projector including light source means for emitting light for projecting an image, holding means for holding air, said holding means including air discharging means directed toward said light source means, and air pump means for holding air in said holding means and compressing air in said holding means, said method being carried out by said projector, said method comprising:
detecting a pressure in said holding means; and
controlling operation of said air pump means based on the detected pressure in order to keep the pressure in the holding means constant.

6. The method of cooling a light source of a projector according to claim 5, further comprising:
storing a target pressure;
wherein said controlling comprises increasing an amount of air in said holding means held by said air pump means to increase a flow rate of air discharged from said air discharging means if the detected pressure is lower than said target pressure, and reducing the amount of air in said holding means held by said air pump means to reduce the flow rate of air discharged from said air discharging means if the detected pressure is higher than said target pressure.

7. The method of cooling a light source of a projector according to claim 5,
wherein said controlling comprises generating setting information for setting the flow rate of air discharged from said air pump means based on the detected pressure, and supplying a drive signal depending on the setting information to said air pump means to control the flow rate of air discharged from said air pump means, and
further comprising determining a malfunction based on said setting information.

8. The method of cooling a light source of a projector according to claim 7, further comprising:
storing a normal range for said setting information;
wherein said determining comprises determining a malfunction if said setting information falls outside of said normal range.

9. A projector, comprising:
a light source that emits light for projecting an image;
a holder that holds air, said holder including an air discharger directed toward said light source;
an air pump that holds air in said holder and compresses air in said holder;
a pressure detector that detects a pressure in said holder; and
a controller that controls operation of said air pump based on the pressure detected by said pressure detector in order to keep the pressure in the holder constant.

10. The projector according to claim 9, wherein said controller stores a target pressure, and said controller increases an amount of air in said holder that is held by said air pump to increase a flow rate of air discharged from said air discharger if the pressure detected by said pressure detector is lower than said target pressure, and reduces the amount of air in said holder held by said air pump to reduce the flow rate of air discharged from said air discharging if the pressure detected by said pressure detector is higher than said target pressure.

11. The projector according to claim 9, wherein said controller generates setting information for setting the flow rate of air discharged from said air pump based on the pressure detected by said pressure detector, supplies a drive signal depending on the setting information to said air pump to control the flow rate of air discharged from said air pump, and determines a malfunction based on said setting information.

12. The projector according to claim 11, wherein said controller stores a normal range for said setting information, and determines a malfunction if said setting information falls outside of said normal range.

13. The method of cooling a light source of a projector according to claim 6,
wherein said controlling comprises generating setting information for setting the flow rate of air discharged from said air pump means based on the detected pressure, and supplying a drive signal depending on the setting information to said air pump means to control the flow rate of air discharged from said air pump means, and
further comprising determining a malfunction based on said setting information.

14. The projector according to claim 10, wherein said controller generates setting information for setting the flow rate of air discharged from said air pump based on the pressure detected by said pressure detector, supplies a drive signal depending on the setting information to said air pump to control the flow rate of air discharged from said air pump, and determines a malfunction based on said setting information.
